(19) United States
(12) Patent Application Publication
(10) Pub. No.: US 2026/0230317 A1
(43) Pub. Date: Aug. 6, 2026

(54) ENCRYPTED COMMUNICATION METHOD, NON-TRANSITORY COMPUTER-READABLE RECORDING MEDIUM, AND CONNECTED DEVICE

(71) Applicant: Panasonic Intellectual Property Management Co., Ltd., Osaka (JP)

(72) Inventor: Naohisa NISHIDA, Kanagawa (JP)

(73) Assignee: Panasonic Intellectual Property Management Co., Ltd., Osaka (JP)

(21) Appl. No.: 19/556,617

(22) Filed: Mar. 4, 2026

Related U.S. Application Data
(63) Continuation of application No. PCT/JP2024/026617, filed on Jul. 25, 2024.

(30) Foreign Application Priority Data
Sep. 12, 2023 (JP) 2023-147599

(51) Int. Cl. H04L 9/08

(52) U.S. Cl. CPC H04L 9/0869; H04L 9/0852

(57) ABSTRACT

In an encrypted communication method, a public key (a first encryption key) is generated using a random seed stored in advance, a random number to be shared with a connected device to be communicated with is obtained through communication using the public key (the first encryption key) generated, and encrypted communication with the connected device is performed using a cryptographic scheme that is usable by using the obtained random number as a symmetric key (a second encryption key).

### CROSS REFERENCE TO RELATED APPLICATIONS

This is a continuation application of PCT International Application No. PCT/JP 2024/026617 filed on Jul. 25, 2024, designating the United States of America, which is based on and claims priority of Japanese Patent Application No. 2023-147599 filed on Sep. 12, 2023. The entire disclosures of the above-identified applications, including the specifications, drawings and claims are incorporated herein by reference in their entirety.

### FIELD

The present disclosure relates to an encrypted communication method, a non-transitory computer-readable recording medium, and a connected device.

### BACKGROUND

Patent Literature (PTL) 1 discloses an information processing device or a signature generating device for realizing a public key authentication scheme or a digital signature scheme using a system of higher-degree multivariate equations for which no efficient solving means (trapdoor) has been known.

### CITATION LIST

### Patent Literature

PTL 1: Japanese Unexamined Patent Application Publication No. 2013-48350

### SUMMARY

### Technical Problem

The present disclosure provides an encrypted communication method, etc. capable of easily switching from a cryptographic scheme for which a vulnerability has been found to a usable cryptographic scheme in a quick manner.

### Solution to Problem

An encrypted communication method according to an aspect of the present disclosure includes: generating a first encryption key using a random seed stored in advance when a cryptographic scheme is updated; and obtaining a random number to be shared with a connected device to be communicated with, by performing encrypted communication with the connected device using a cryptographic scheme that is usable by using the first encryption key generated. The random number obtained is used as a second encryption key to perform encrypted communication with the connected device.

A non-transitory computer-readable recording medium according to an aspect of the present disclosure is a non-transitory computer-readable recording medium having recorded thereon a program for causing one or more processors to execute the encrypted communication method described above.

A connected device according to an aspect of the present disclosure includes an encryption key generator and a communicator. The encryption key generator generates a first encryption key using a random seed stored in advance when a cryptographic scheme is updated. The communicator obtains a random number to be shared with a connected device to be communicated with, by performing encrypted communication with the connected device using a cryptographic scheme that is usable by using the first encryption key generated by the encryption key generator. The random number obtained by the communicator is used as a second encryption key to perform encrypted communication with the connected device.

### Advantageous Effects

According to the present disclosure, there is provided an advantage of being able to easily switch from a cryptographic scheme for which a vulnerability has been found to a usable cryptographic scheme in a quick manner.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating an example of a general configuration including connected devices according to an embodiment.

FIG. 2 is a block diagram illustrating an example of a functional configuration of a management server according to the embodiment.

FIG. 3 is a diagram illustrating an example of a random seed.

FIG. 4 is a diagram illustrating an example of cryptographic scheme information.

FIG. 5 is a block diagram illustrating an example of a functional configuration of a connected device according to the embodiment.

FIG. 6 is a diagram illustrating an example of an encryption key.

FIG. 7 is a diagram illustrating an example of a list of cryptographic schemes.

FIG. 8 is a sequence diagram illustrating a first operation example in the general configuration including the connected devices according to the embodiment.

FIG. 9 is a sequence diagram illustrating a second operation example in the general configuration including the connected devices according to the embodiment.

FIG. 10 is a diagram illustrating an example of updated cryptographic scheme information.

FIG. 11 is a sequence diagram illustrating a third operation example in the general configuration including the connected devices according to the embodiment.

FIG. 12 is a sequence diagram illustrating an example of encrypted communication by the connected devices according to the embodiment.

FIG. 13 is a sequence diagram illustrating an operation example in the general configuration including the connected devices according to Variation 1 of the embodiment.

FIG. 14 is a sequence diagram illustrating an operation example in the general configuration including the connected devices according to Variation 2 of the embodiment.

FIG. 15 is a sequence diagram illustrating another operation example in the general configuration including the connected devices according to Variation 2 of the embodiment.

FIG. 16 is a sequence diagram illustrating an operation example in the general configuration including the connected devices according to Variation 3 of the embodiment.

FIG. 17 is a diagram illustrating an example of an encryption key generated for each of cryptographic schemes.

FIG. 18 is a sequence diagram illustrating another operation example in the general configuration including the connected devices according to Variation 3 of the embodiment.

FIG. 19 is a block diagram illustrating an example of a functional configuration of a connected device according to Variation 4 of the embodiment.

FIG. 20 is a diagram illustrating an example of a random seed for each of an encryption key and parameters.

### DESCRIPTION OF EMBODIMENTS

### Underlying Knowledge Forming Basis of the Present Disclosure

In recent years, with the advent of quantum computers, the development of quantum computers has been actively conducted. With the scaling up of quantum computers, on the other hand, cryptographic schemes currently in use (hereinafter, also referred to as “classical cryptographic schemes”) are known to become theoretically compromised. In view of such circumstances, post-quantum cryptographic schemes, which are new cryptographic schemes capable of withstanding the computing performance of large-scale quantum computers, have been proposed.

Even for the post-quantum cryptographic schemes, however, the evaluation of their security is imperfect. Thus, even after a post-quantum cryptographic scheme is adopted in a connected device, a vulnerability may be found in the post-quantum cryptographic scheme. When a vulnerability is found in the cryptographic scheme currently in use, the connected device needs to immediately switch to another cryptographic scheme in order to ensure the security of communication.

In a state where a vulnerability has been found in the cryptographic scheme currently in use, however, a new encryption key cannot be distributed to the connected device via a network because the security of communication is no longer guaranteed. This creates a problem in which the connected device cannot quickly switch from the cryptographic scheme currently in use to a usable cryptographic scheme.

In view of the above, the present disclosure provides an encrypted communication method, etc. capable of easily switching from a cryptographic scheme for which a vulnerability has been found to a usable cryptographic scheme in a quick manner by generating a new encryption key in a connected device using a random seed stored in advance.

More specifically, an encrypted communication method according to a first aspect of the present disclosure includes: generating a first encryption key using a random seed stored in advance when a cryptographic scheme is updated; and obtaining a random number to be shared with a connected device to be communicated with, by performing encrypted communication with the connected device using a cryptographic scheme that is usable by using the first encryption key generated. The random number obtained is used as a second encryption key to perform encrypted communication with the connected device.

According to this, when the cryptographic scheme is updated, the encryption key is generated based on the random seed stored in advance. This eliminates the need to distribute a new encryption key to the connected device via a network. Thus, this provides an advantage of being able to easily switch from the cryptographic scheme for which a vulnerability has been found to the cryptographic scheme that is usable in a quick manner.

Furthermore, in an encrypted communication method according to a second aspect of the present disclosure, for example, when a plurality of cryptographic schemes that are usable are present in the first aspect, a cryptographic scheme that is usable with the connected device is selected from among the plurality of cryptographic schemes, and the encrypted communication is performed using the cryptographic scheme selected.

According to this, the cryptographic scheme that is usable with the connected device to be communicated with is selected to perform the encrypted communication. This prevents encrypted communication from being performed using a cryptographic scheme unsupported by the connected device to be communicated with. Thus, this provides an advantage of facilitating the establishment of encrypted communication with the connected device to be communicated with.

Furthermore, in an encrypted communication method according to a third aspect of the present disclosure, for example, the cryptographic scheme in the first aspect or the second aspect is a post-quantum cryptographic scheme.

According to this, deciphering is more difficult compared with the case where encrypted communication is performed using a classical cryptographic scheme. Thus, this provides an advantage of being able to easily ensure the confidentiality of data to be transmitted or received.

Furthermore, in an encrypted communication method according to a fourth aspect of the present disclosure, for example, when cryptographic scheme information indicating that the cryptographic scheme that is usable has been updated is obtained from a management server that manages the cryptographic scheme that is usable in any one of the first to third aspects, the cryptographic scheme that is usable is updated based on the cryptographic scheme information obtained.

According to this, the cryptographic scheme that is usable is updated. Thus, this provides an advantage of being able to easily switch to a usable cryptographic scheme in a quick manner when a vulnerability is found in the cryptographic scheme that has been used, for example.

Furthermore, in an encrypted communication method according to a fifth aspect of the present disclosure, for example, the cryptographic scheme that is usable that has been updated in the fourth aspect is transmitted to an other connected device.

According to this, the other connected device can update the cryptographic scheme that is usable without the intervention of the management server. Thus, this provides an advantage of being able to update the cryptographic scheme that is usable even when the other connected device cannot communicate with the management server, for example.

Furthermore, in an encrypted communication method according to a sixth aspect of the present disclosure, for example, a parameter of the cryptographic scheme that is usable is generated using an other random seed that is stored in advance and is different from the random seed in any one of the first to fifth aspects.

According to this, by using separate random seeds for generating the encryption key and for generating the parameter, the number of times the random seed for generating the encryption key, i.e., the algorithm for generating the encryption key, is used can be reduced as much as possible. Thus, this provides an advantage of making it easier to ensure the confidentiality of the process for generating the encryption key.

Furthermore, a program according to a seventh aspect of the present disclosure causes one or more processors to execute the encrypted communication method according to any one of the first to sixth aspects, for example.

This provides an advantage of being able to obtain the same effects as those of the above-described encrypted communication method.

Furthermore, a connected device according to an eighth aspect of the present disclosure includes an encryption key generator and a communicator, for example. The encryption key generator generates a first encryption key using a random seed stored in advance when a cryptographic scheme is updated. The communicator obtains a random number to be shared with a connected device to be communicated with, by performing encrypted communication with the connected device using a cryptographic scheme that is usable by using the first encryption key generated by the encryption key generator. The random number obtained by the communicator is used as a second encryption key to perform encrypted communication with the connected device.

This provides an advantage of being able to obtain the same effects as those of the above-described encrypted communication method.

Furthermore, these general or specific aspects may be implemented using a system, a device, a method, an integrated circuit, a computer program, or a computer-readable recording medium such as a CD-ROM, or any combination of systems, devices, methods, integrated circuits, computer programs, and recording media.

Hereinafter, certain exemplary embodiments are described in greater detail with reference to the accompanying Drawings. Each of the exemplary embodiments described below shows a general or specific example. The numerical values, shapes, materials, elements, the arrangement and connection of the elements, steps, the processing order of the steps, etc. shown in the following exemplary embodiments are mere examples, and therefore do not limit the scope of the present disclosure. Therefore, among the elements in the following exemplary embodiments, those not recited in any one of the independent claims are described as optional elements. Note that each of the Drawings is a schematic diagram and is not necessarily an illustration drawn in a strict sense. Furthermore, in each of the Drawings, substantially identical elements are denoted by the same reference numerals, and duplicated descriptions may be omitted or simplified.

### EMBODIMENT

### 1. Overview

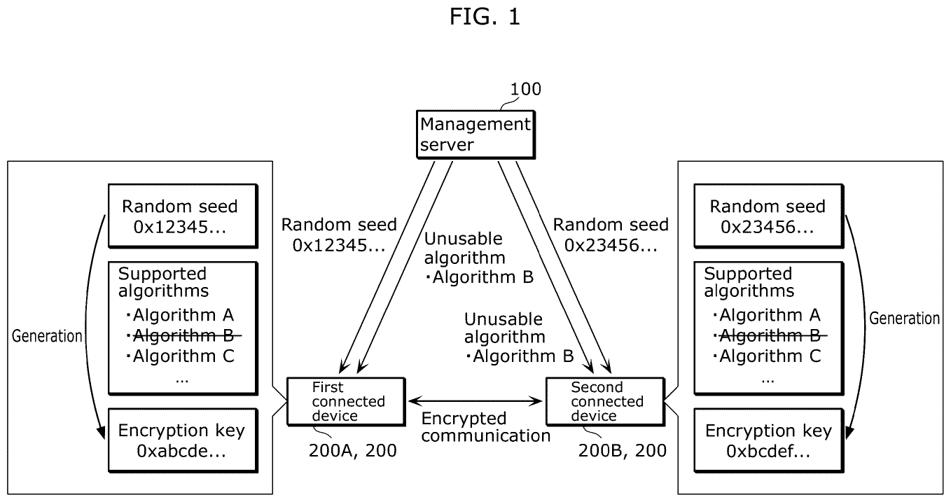

An overview of an encrypted communication method according to an embodiment will be described first with reference to FIG. 1. FIG. 1 is a block diagram illustrating an example of a general configuration including connected devices 200 according to the embodiment. As shown in FIG. 1, encrypted communication (encryption communication) is assumed to be performed between two connected devices 200 in this embodiment. Hereinafter, one of two connected devices 200 will be referred to as “first connected device 200A”, and the other of two connected devices 200 will be referred to as “second connected device 200B”.

Management server 100 manages usable algorithms (cryptographic schemes). The usable algorithms as used herein refer to algorithms for which no vulnerability has been found. Management server 100 also transmits a different random seed to each of first connected device 200A and second connected device 200B. In the embodiment, management server 100 transmits the random seeds to two connected devices 200. When three or more connected devices 200 are present, however, management server 100 may transmit random seeds to three or more connected devices 200.

Here, management server 100 transmits the random seeds to first connected device 200A and second connected device 200B at a point before the usable algorithms are updated, for example. Therefore, the random seeds are assigned to first connected device 200A and second connected device 200B before their usable algorithms are updated.

A random seed and a list of supported algorithms (usable cryptographic schemes) are stored in each of first connected device 200A and second connected device 200B. A random seed of “0x12345 . . . ” and a list of supported algorithms including Algorithm A, Algorithm B, and Algorithm C are stored in first connected device 200A. Also, a random seed of “0x23456 . . . ” and a list of supported algorithms including Algorithm A, Algorithm B, and Algorithm C are stored in second connected device 200B.

Here, when a vulnerability is found in Algorithm B and Algorithm B therefore becomes unusable as shown in FIG. 1, management server 100 transmits, to first connected device 200A and second connected device 200B, information indicating that Algorithm B is an unusable algorithm. Each of first connected device 200A and second connected device 200B then deletes Algorithm B from the list of supported algorithms and generates an encryption key based on the random seed stored in advance. Note that a specific method of generating the encryption key based on the random seed will be described later.

As described above, when the cryptographic schemes (supported algorithms) are updated in connected device 200 (the encrypted communication method) according to the embodiment, the encryption key is generated based on the random seed stored in advance. This eliminates the need to distribute a new encryption key to connected device 200 via a network. Thus, connected device 200 (the encrypted communication method) according to the embodiment provides an advantage of being able to easily switch from the cryptographic scheme for which a vulnerability has been found to a usable cryptographic scheme in a quick manner when the cryptographic schemes are updated.

### 2. Configuration

The general configuration including the connected devices according to the embodiment will be described next. As already mentioned, the embodiment is described assuming that communication is performed between two connected devices 200 (first connected device 200A and second connected device 200B) via a network such as the Internet. Connected device 200 is implemented by an information terminal such as a personal computer, a smartphone, or a tablet terminal, for example. Furthermore, two connected devices 200 are each configured to be capable of communicating with management server 100 via a network such as the Internet.

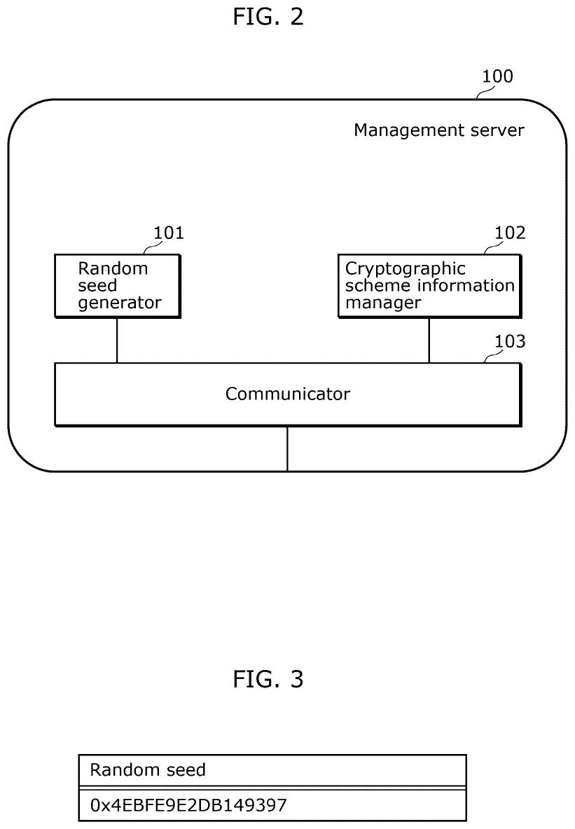

FIG. 2 is a block diagram illustrating an example of a functional configuration of management server 100 according to the embodiment. Management server 100 includes a processor and a memory, and the functions of management server 100 are implemented by the processor executing a program stored in the memory. As shown in FIG. 2, management server 100 includes random seed generator 101, cryptographic scheme information manager 102, and communicator 103.

Random seed generator 101 generates a random seed to be stored in advance in each of connected devices 200. FIG. 3 is a diagram illustrating an example of such a random seed. As shown in FIG. 3, random seed generator 101 generates a 16-bit random seed, for example. Random seed generator 101 generates the random seed by executing an appropriate generation algorithm, for example. In the embodiment, random seed generator 101 generates a different random seed for each of connected devices 200.

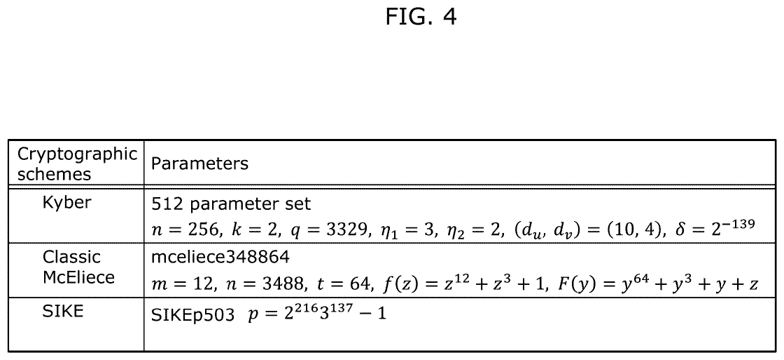

Cryptographic scheme information manager 102 manages cryptographic scheme information about one or more usable cryptographic schemes. FIG. 4 is a diagram illustrating an example of such cryptographic scheme information. As shown in FIG. 4, the cryptographic scheme information includes one or more usable cryptographic schemes and parameters used for each of the cryptographic schemes.

In the example shown in FIG. 4, the one or more cryptographic schemes include “CRYSTALS Kyber” (“Kyber” in FIG. 4), “Classic McEliece”, and “Supersingular Isogeny Key Encapsulation (SIKE)”, which are post-quantum cryptographic schemes.

With regard to “CRYSTALS Kyber”, see “CRYSTALS-Kyber Algorithm Specifications And Supporting Documentation (version 3.01), Roberto Avanzi et al., Jan. 31, 2021”. With regard to “Classic McEliece”, see “Classic McEliece: conservative code-based cryptography: cryptosystem specification, 23 Oct. 2022”. With regard to “SIKE”, see “Supersingular Isogeny Key Encapsulation, David Jao et al., University of Waterloo and evolutionQ, Inc., Aug. 23, 2019”. Note that the one or more cryptographic schemes are not limited to the above cryptographic schemes and may include other cryptographic schemes.

The parameters used in each of the cryptographic schemes include a length of an encryption key, for example, and are parameters used for the generation of the encryption key, encryption of data using the encryption key, or decryption of the encrypted data. When a vulnerability is found in any of the cryptographic schemes, for example, the vulnerability may be eliminated by updating the parameters used in that cryptographic scheme, thus ensuring the security of that cryptographic scheme.

Upon receiving an input to update the cryptographic scheme information, for example, cryptographic scheme information manager 102 updates the cryptographic scheme information stored in the memory. The updating of the cryptographic scheme information as used herein refers to, for example, deleting any of the cryptographic schemes or updating the parameters used in any of the cryptographic schemes. The updating of the cryptographic scheme information is performed when a vulnerability is found in any of the one or more cryptographic schemes, for example.

Communicator 103 transmits the random seed(s) generated by random seed generator 101 to one or more connected devices 200 to be communicated with. Basically, the transmission of such a random seed to each of connected devices 200 is performed only when the use of each of connected devices 200 is started. In the embodiment, communicator 103 transmits a different random seed to each of first connected device 200A and second connected device 200B.

Communicator 103 also transmits, to one or more connected devices 200 to be communicated with, the cryptographic scheme information managed by cryptographic scheme information manager 102. Basically, the transmission of the cryptographic scheme information to each of connected devices 200 is performed when the use of each of connected devices 200 is started or when the cryptographic scheme information has been updated. In the embodiment, communicator 103 transmits, to first connected device 200A and second connected device 200B, the cryptographic scheme information, or updated cryptographic scheme information when the cryptographic scheme information has been updated. Note that the cryptographic scheme information transmitted by communicator 103 to each of connected devices 200 may be information indicating that a vulnerability has been found in any of the cryptographic schemes, information indicating updated parameters of any of the cryptographic schemes, or information indicating a new cryptographic scheme, for example.

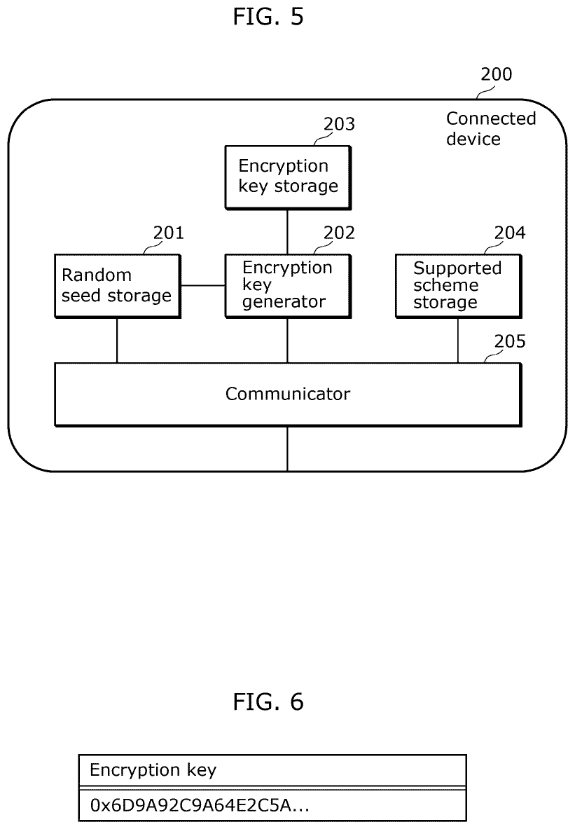

FIG. 5 is a block diagram illustrating an example of a functional configuration of connected device 200 according to the embodiment. In the embodiment, each of first connected device 200A and second connected device 200B is assumed to have the configuration of connected device 200 shown in FIG. 5. Connected device 200 includes a processor and a memory, and the functions of connected device 200 are implemented by the processor executing a program stored in the memory. As shown in FIG. 5, connected device 200 includes random seed storage 201, encryption key generator 202, encryption key storage 203, supported scheme storage 204, and communicator 205.

Random seed storage 201 stores the random seeds received from management server 100 by communicator 205.

When performing encrypted communication with other connected device 200, encryption key generator 202 generates, by using the random seed stored in random seed storage 201, an encryption key according to a cryptographic scheme to be used. Although encryption keys generated by encryption key generator 202 in the embodiment are a public key and a private key as described below, the present disclosure is not limited to this. FIG. 6 is a diagram illustrating an example of an encryption key. As shown in FIG. 6, encryption key generator 202 generates an encryption key having a bit string of 16 bits or more, for example. Encryption key generator 202 generates an encryption key for each of the cryptographic schemes by executing an encryption key generation algorithm appropriate for the cryptographic scheme.

Encryption key storage 203 stores the encryption key generated by encryption key generator 202 for each of the cryptographic schemes.

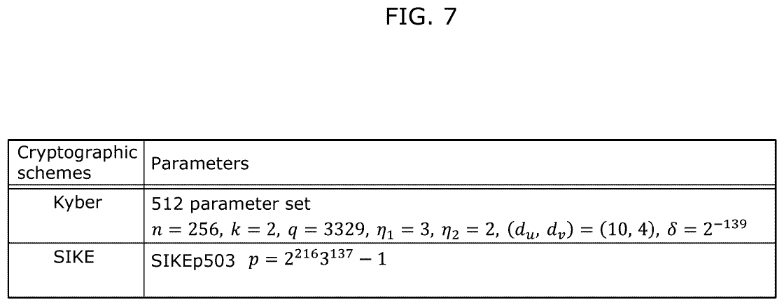

Supported scheme storage 204 stores a list of cryptographic schemes supported by connected device 200 (i.e., usable by connected device 200) (hereinafter, also referred to simply as a “list of cryptographic schemes”). FIG. 7 is a diagram illustrating an example of the list of cryptographic schemes. In the example shown in FIG. 7, the list of cryptographic schemes includes “CRYSTALS Kyber” (“Kyber” in FIG. 7) and “SIKE”, which are post-quantum cryptographic schemes.

In the embodiment, supported scheme storage 204 stores the list of cryptographic schemes based on the cryptographic scheme information received from management server 100 by communicator 205. Based on the updated cryptographic scheme information received from management server 100 by communicator 205, supported scheme storage 204 also updates the list of cryptographic schemes that has been stored. When the updated cryptographic scheme information is information indicating that a vulnerability has been found in any of the cryptographic schemes, for example, supported scheme storage 204 updates the list of cryptographic schemes by deleting such a cryptographic scheme from the list of cryptographic schemes. Furthermore, also when a new usable cryptographic scheme is added as a result of an update of connected device 200, for example, supported scheme storage 204 updates the list of cryptographic schemes by adding such a cryptographic scheme to the list of cryptographic schemes.

Communicator 205 receives the random seed and the cryptographic scheme information from management server 100. Furthermore, when performing encrypted communication with other connected device 200, communicator 205 transmits and receives various data required for the encrypted communication to and from other connected device 200.

### 3. Operations

Operation examples in the general configuration including connected devices 200 according to the embodiment will be described below.

### 3-1. First Operation Example

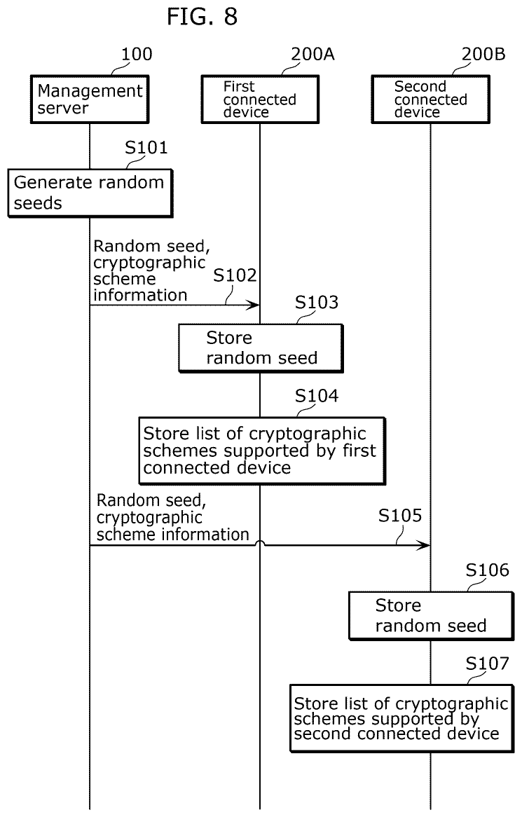

FIG. 8 is a sequence diagram illustrating a first operation example in the general configuration including connected devices 200 according to the embodiment. The first operation example is performed when the use of each of connected devices 200 is started, for example. The following description is made assuming that the use of first connected device 200A and second connected device 200B is started.

First, management server 100 generates random seeds (S101). Here, management server 100 generates a random seed for first connected device 200A and a random seed for second connected device 200B. Management server 100 then transmits, to first connected device 200A, the generated random seed for first connected device 200A and cryptographic scheme information managed by management server 100 (S102).

Upon receiving the random seed and the cryptographic scheme information, first connected device 200A stores the received random seed in random seed storage 201 (S103). First connected device 200A also stores a list of cryptographic schemes supported by first connected device 200A in supported scheme storage 204 based on the received cryptographic scheme information (S104). Note that steps S103 and S104 may be performed in reverse order or in parallel.

Next, management server 100 transmits, to second connected device 200B, the generated random seed for second connected device 200B and the cryptographic scheme information managed by management server 100 (S105). Note that steps S102 and S105 may be performed in reverse order or in parallel.

Upon receiving the random seed and the cryptographic scheme information, second connected device 200B stores the received random seed in random seed storage 201 (S106). Second connected device 200B also stores a list of cryptographic schemes supported by second connected device 200B in supported scheme storage 204 based on the received cryptographic scheme information (S107). Note that steps S106 and S107 may be performed in reverse order or in parallel.

### 3-2. Second Operation Example

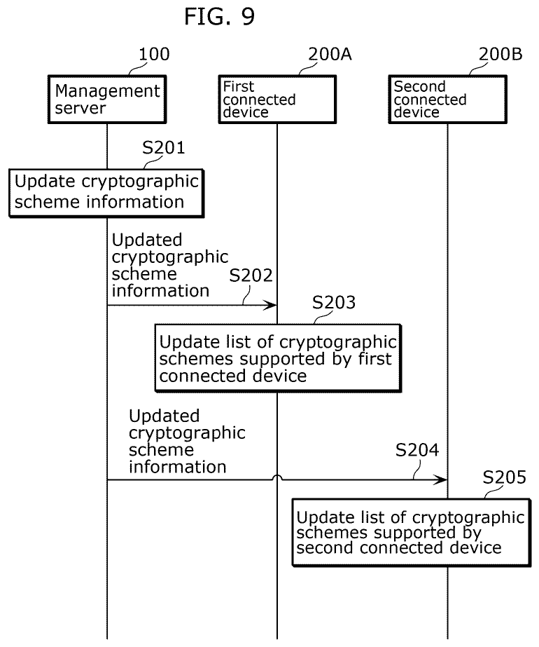

FIG. 9 is a sequence diagram illustrating a second operation example in the general configuration including connected devices 200 according to the embodiment. The second operation example is performed when management server 100 receives an input to update cryptographic scheme information, for example.

First, management server 100 updates the cryptographic scheme information (S201). Management server 100 then transmits the updated cryptographic scheme information to first connected device 200A (S202).

Upon receiving the updated cryptographic scheme information, first connected device 200A updates a list of cryptographic schemes supported by first connected device 200A based on the received cryptographic scheme information, and stores the updated list of cryptographic schemes in supported scheme storage 204 (S203).

Next, management server 100 transmits the updated cryptographic scheme information to second connected device 200B (S204). Note that steps S202 and S204 may be performed in reverse order or in parallel.

Upon receiving the updated cryptographic scheme information, second connected device 200B updates a list of cryptographic schemes supported by second connected device 200B based on the received cryptographic scheme information, and stores the updated list of cryptographic schemes in supported scheme storage 204 (S205).

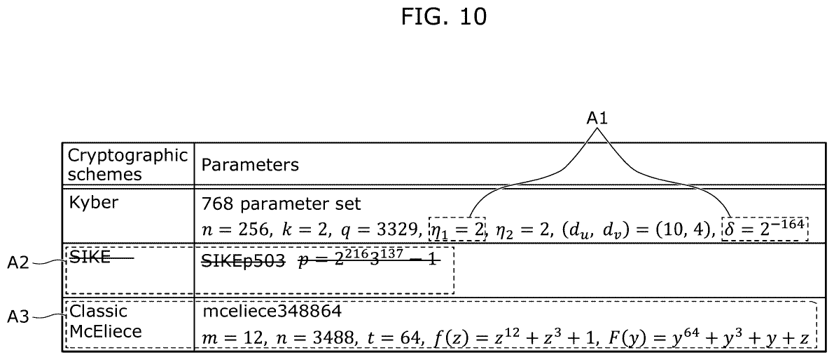

FIG. 10 is a diagram illustrating an example of the updated cryptographic scheme information. In FIG. 10, areas A1 surrounded by broken lines each show a parameter of an updated cryptographic scheme, area A2 shows a deleted cryptographic scheme, and area A3 shows an added cryptographic scheme. In the example shown in FIG. 10, since a vulnerability has been found in “CRYSTALS Kyber” (“Kyber” in FIG. 10), which is a post-quantum cryptographic scheme, the vulnerability is eliminated by updating the parameters of “CRYSTALS Kyber”. In the example shown in FIG. 10, since a vulnerability has been found in “SIKE”, which is a post-quantum cryptographic scheme, “SIKE” is made unusable by deleting “SIKE”. In the example shown in FIG. 10, “Classic McEliece”, which is a post-quantum cryptographic scheme, is newly made usable by adding “Classic McEliece”.

### 3-3. Third Operation Example

FIG. 11 is a sequence diagram illustrating a third operation example in the general configuration including connected devices 200 according to the embodiment. The third operation example is performed when encrypted communication, such as transmitting and receiving data, is performed between two connected devices 200 after cryptographic scheme information was updated, for example. The example shown in FIG. 11 is described assuming that communication is performed between first connected device 200A and second connected device 200B. Furthermore, although communication between first connected device 200A and second connected device 200B is initiated from second connected device 200B in the example shown in FIG. 11, the communication may be initiated from first connected device 200A.

First, second connected device 200B transmits, to first connected device 200A, a list of cryptographic schemes supported by second connected device 200B (S301). Upon receiving the list of cryptographic schemes, first connected device 200A compares the received list of cryptographic schemes with a list of cryptographic schemes supported by first connected device 200A to select one of cryptographic schemes supported by both first connected device 200A and second connected device 200B (S302). First connected device 200A then transmits the selected cryptographic scheme (i.e., the cryptographic scheme to be used) to second connected device 200B (S303).

First connected device 200A generates an encryption key corresponding to the selected cryptographic scheme by using a random seed stored in random seed storage 201 (i.e., a random seed for first connected device 200A) (S304). Also, second connected device 200B generates an encryption key corresponding to the selected cryptographic scheme by using a random seed stored in random seed storage 201 (i.e., a random seed for second connected device 200B) (S305). Thereafter, each of first connected device 200A and second connected device 200B performs a setup process and encrypted communication using the generated encryption key (S306). Note that step S305 may be included in the setup process in step S306.

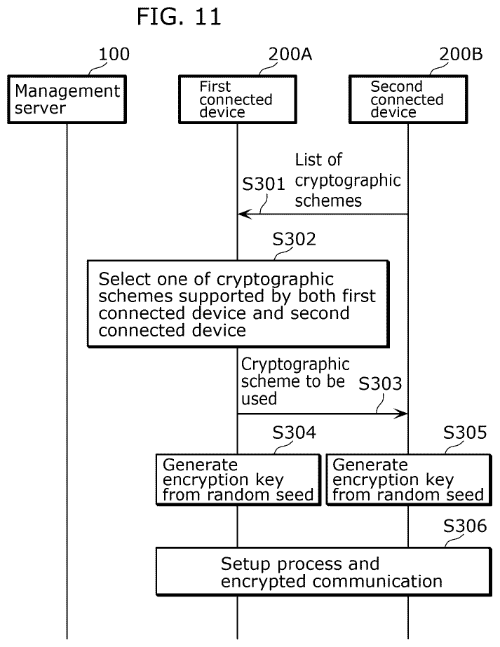

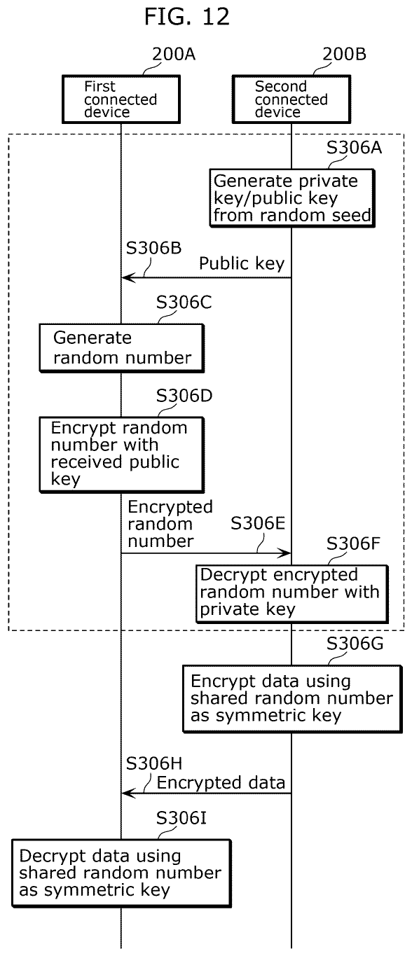

FIG. 12 is a sequence diagram illustrating an example of encrypted communication by connected devices 200 according to the embodiment. Steps S306A to S306F surrounded by a broken line in FIG. 12 correspond to the setup process. Note that the setup process may include processes other than those of steps S306A to S306F. The example shown in FIG. 12 is described assuming that encrypted communication is performed between first connected device 200A and second connected device 200B. Although the encrypted communication between first connected device 200A and second connected device 200B is initiated from second connected device 200B in the example shown in FIG. 12, the encrypted communication may be initiated from first connected device 200A.

First, by using the random seed stored in random seed storage 201 (i.e., the random seed for second connected device 200B), second connected device 200B generates a private key and a public key (i.e., encryption keys) corresponding to the cryptographic scheme to be used (S306A). Step S306A is a process of the encrypted communication method according to the embodiment. The entity that performs step S306A is encryption key generator 202 in connected device 200 according to the embodiment. In other words, in the encrypted communication method (encryption key generator 202), a first encryption key (in this case, a public key) is generated using the random seed stored in advance (in this case, the random seed for second connected device 200B) when the cryptographic schemes are updated. Note that step S306A corresponds to step S305 in FIG. 11.

Next, second connected device 200B transmits the generated public key (the first encryption key) to first connected device 200A (S306B). Upon receiving the public key, first connected device 200A generates a random number using the random seed stored in random seed storage 201 (i.e., the random seed for first connected device 200A) (S306C). First connected device 200A then encrypts the generated random number with the received public key (S306D). First connected device 200A then transmits the random number that has been encrypted (encrypted random number) to second connected device 200B (S306E). Upon receiving the encrypted random number, second connected device 200B decrypts the received encrypted random number with the private key that is paired with the public key (S306F). Second connected device 200B thus obtains the random number generated by first connected device 200A, i.e., the random number shared by first connected device 200A and second connected device 200B. Steps S306B and S306E are performed via encrypted communication using the cryptographic scheme usable by both first connected device 200A and second connected device 200B (in this case, a post-quantum cryptographic scheme).

Each of the processes in steps S306B and S306E is a process of the encrypted communication method according to the embodiment. The entity that performs steps S306A and S306F is communicator 205 in connected device 200 according to the embodiment. In other words, in the encrypted communication method (communicator 205), the random number to be shared with connected device 200 to be communicated with (in this case, first connected device 200A) is obtained by performing encrypted communication with such connected device 200 using the cryptographic scheme that is usable by using the generated public key (the first encryption key).

Thereafter, when second connected device 200B transmits data to first connected device 200A via encrypted communication, second connected device 200B encrypts the data using the shared random number as a symmetric key (a second encryption key) (S306G). Second connected device 200B then transmits the data that has been encrypted (encrypted data) to first connected device 200A (S306H). Upon receiving the encrypted data, first connected device 200A decrypts the encrypted data using the shared random number as a symmetric key (S306I). In this manner, the data can be transmitted from second connected device 200B to first connected device 200A via encrypted communication. In other words, the random number obtained by communicator 205 (shared random number) is used as the symmetric key (the second encryption key) for encrypted communication with connected device 200 (in this case, first connected device 200A).

### 4. Advantages

Advantages of the connected device and the encrypted communication method according to the embodiment will be described below. As described above, in the connected device (the encrypted communication method) according to the embodiment, the encryption key (the second encryption key), which is the random number to be shared with the connected device to be communicated with, is generated based on the random seed stored in advance when the cryptographic schemes are updated. In this manner, the connected device autonomously generates a new encryption key in the connected device (the encrypted communication method) according to the embodiment, thus eliminating the need to distribute a new encryption key from the management server to the connected device via a network. Therefore, connected device 200 (the encrypted communication method) according to the embodiment provides advantages of eliminating the need to take into consideration the security of communication via the network and thus being able to easily switch from a cryptographic scheme for which a vulnerability has been found to a usable cryptographic scheme in a quick manner when the cryptographic schemes are updated.

### Other Embodiments

Although the embodiment has been described above, the present disclosure is not limited to the above-described embodiment.

### Variation 1

FIG. 13 is a sequence diagram illustrating an operation example in the general configuration including connected devices 200 according to Variation 1 of the embodiment. In Variation 1, even when cryptographic scheme information is updated, management server 100 does not transmit the updated cryptographic scheme information to each of connected devices 200. In Variation 1, in contrast, connected device 200 (in this case, first connected device 200A) obtains the updated cryptographic scheme information as a result of querying management server 100 about an update of the cryptographic scheme information. This will be specifically described below.

First, management server 100 updates cryptographic scheme information (S201) as with the second operation example of the embodiment. Connected device 200 (in this case, first connected device 200A) periodically queries management server 100 as to whether the cryptographic scheme information has been updated (S206). Upon receiving the query, management server 100 performs a process to check whether the cryptographic scheme information has been updated. When there is no update (S207: No), management server 100 terminates the process. When there is an update (S207: Yes), on the other hand, management server 100 transmits the updated cryptographic scheme information to connected device 200 that is a query source (in this case, first connected device 200A) (S208).

Upon receiving the updated cryptographic scheme information, first connected device 200A updates a list of cryptographic schemes supported by first connected device 200A based on the received cryptographic scheme information, and stores the updated list of cryptographic schemes in supported scheme storage 204 (S209). As described above, connected device 200 may update the list of cryptographic schemes based on the cryptographic scheme information by autonomously querying management server 100 as to whether the cryptographic scheme information has been updated.

### Variation 2

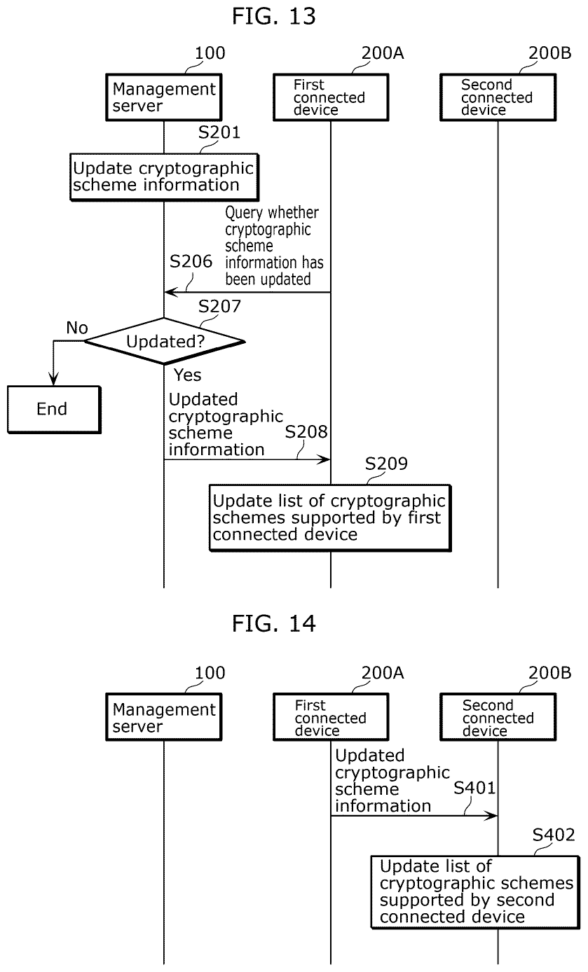

FIG. 14 is a sequence diagram illustrating an operation example in the general configuration including connected devices 200 according to Variation 2 of the embodiment. Variation 2 differs from Variation 1 in that connected device 200 that has updated a list of cryptographic schemes (in this case, first connected device 200A) transmits the updated cryptographic scheme information to other connected device 200 (in this case, second connected device 200B). This will be specifically described below.

First connected device 200A transmits the updated cryptographic scheme information to second connected device 200B (S401). Step S401 may be performed before or after starting encrypted communication with second connected device 200B. Upon receiving the updated cryptographic scheme information, second connected device 200B updates a list of cryptographic schemes supported by second connected device 200B based on the received cryptographic scheme information, and stores the updated list of cryptographic schemes in supported scheme storage 204 (S402).

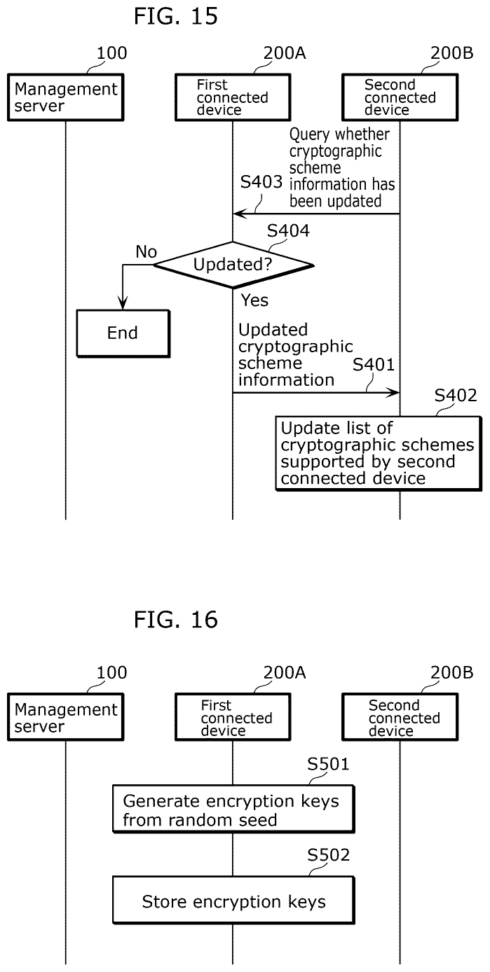

Note that connected device 200 (in this case, second connected device 200B) may obtain the updated cryptographic scheme information as a result of querying other connected device 200 (in this case, first connected device 200A) about an update of cryptographic scheme information as shown in FIG. 15. FIG. 15 is a sequence diagram illustrating another operation example in the general configuration including connected devices 200 according to Variation 2 of the embodiment.

Second connected device 200B periodically queries first connected device 200A as to whether cryptographic scheme information has been updated (S403). Upon receiving the query, first connected device 200A performs a process to check whether the cryptographic scheme information has been updated. When there is no update (S404: No), first connected device 200A terminates the process. When there is an update (S404: Yes), on the other hand, first connected device 200A transmits the updated cryptographic scheme information to second connected device 200B (S401) as with the operation shown in FIG. 14.

As with the operation shown in FIG. 14, upon receiving the updated cryptographic scheme information, second connected device 200B updates a list of cryptographic schemes supported by second connected device 200B based on the received cryptographic scheme information, and stores the updated list of cryptographic schemes in supported scheme storage 204 (S402). As described above, even when connected device 200 cannot communicate with management server 100, for example, connected device 200 can obtain the updated cryptographic scheme information from other connected device 200.

### Variation 3

FIG. 16 is a sequence diagram illustrating an operation example in the general configuration including connected devices 200 according to Variation 3 of the embodiment. In the embodiment, connected device 200 generates an encryption key each time connected device 200 performs encrypted communication with other connected device 200. On the other hand, Variation 3 differs from the embodiment in that connected device 200 (in this case, first connected device 200A) generates encryption keys (a public key and a private key) in advance and performs encrypted communication using the generated encryption keys, i.e., no encryption key is generated each time encrypted communication is performed. This will be specifically described below.

First connected device 200A generates encryption keys (a public key and a private key) using a random seed stored in random seed storage 201 (i.e., a random seed for first connected device 200A) for each of some or all of a list of cryptographic schemes supported by first connected device 200A (S501). First connected device 200A then stores the generated encryption keys in encryption key storage 203 for each of the cryptographic schemes (S502). In Variation 3, since the generated encryption keys are used to perform encrypted communication with other connected device 200, steps S304 and S305 (or step S306A) in the third operation example of the embodiment become unnecessary.

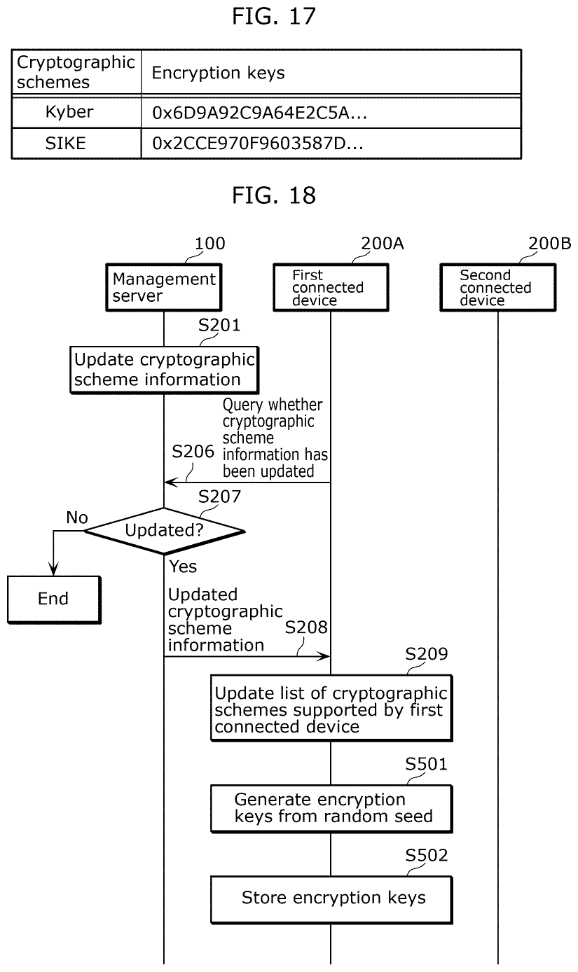

FIG. 17 is a diagram illustrating an example of an encryption key generated for each of cryptographic schemes. In the example shown in FIG. 17, encryption keys for “CRYSTALS Kyber” (“Kyber” in FIG. 17) and “SIKE”, which are post-quantum cryptographic schemes included in the list of cryptographic schemes supported by first connected device 200A, are generated. As described above, since connected device 200 can repeatedly use the encryption keys generated in advance, there is no need to generate an encryption key each time connected device 200 performs encrypted communication with other connected device 200. This provides an advantage of being able to easily reduce the processing load required for encrypted communication.

Note that connected device 200 (in this case, first connected device 200A) may generate encryption keys in response to an update of cryptographic schemes as shown in FIG. 18. FIG. 18 is a sequence diagram illustrating another operation example in the general configuration including connected devices 200 according to Variation 3 of the embodiment. Note that step S201 and steps S206 to S209 shown in FIG. 18 are the same as the operations shown in FIG. 13, and their descriptions will be therefore omitted here.

Upon updating the list of cryptographic schemes supported by first connected device 200A, first connected device 200A generates encryption keys using the random seed for each of some or all of the updated list of cryptographic schemes (S501) as with the operation shown in FIG. 16. First connected device 200A then stores the generated encryption keys in encryption key storage 203 for each of the cryptographic schemes (S502) as with the operation shown in FIG. 16.

### Variation 4

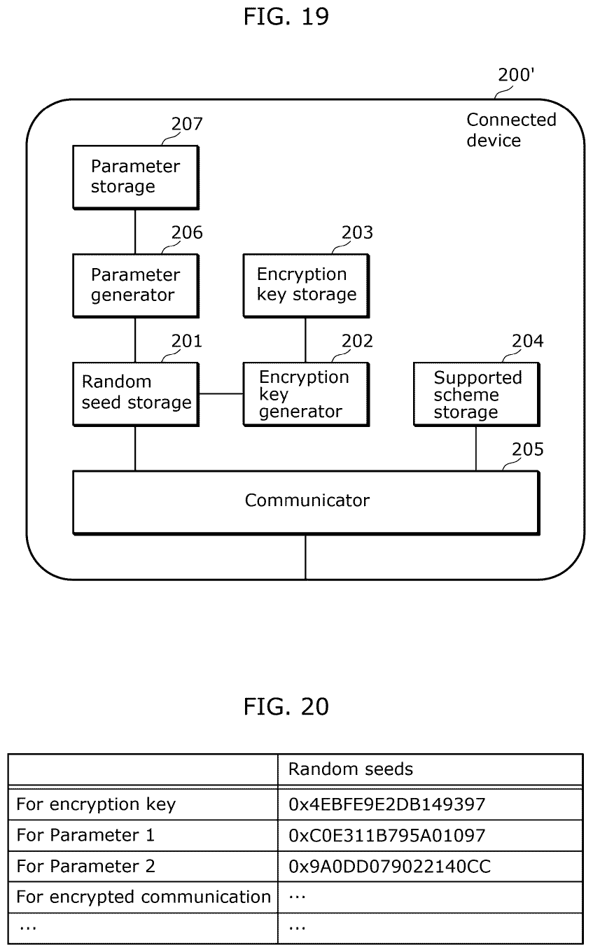

FIG. 19 is a block diagram illustrating an example of a functional configuration of connected device 200′ according to Variation 4 of the embodiment. As shown in FIG. 19, connected device 200′ according to Variation 4 differs from connected device 200 according to the embodiment in further including parameter generator 206 and parameter storage 207.

By using random seeds that are stored in random seed storage 201 and are different from a random seed used to generate an encryption key, parameter generator 206 generates cryptographic scheme parameters corresponding to a cryptographic scheme to be used. In other words, in this encrypted communication method (parameter generator 206), parameters of a usable cryptographic scheme are generated using other random seeds stored in advance, which are different from the random seed (the random seed for generating the encryption key).

Parameter storage 207 stores the parameters generated by parameter generator 206 for each of cryptographic schemes.

FIG. 20 is a diagram illustrating an example of a random seed for each of an encryption key and parameters. In the example shown in FIG. 20, the random seed for the “encryption key”, the random seed for “Parameter 1”, the random seed for “Parameter 2”, and a random seed for “encrypted communication” are stored in random seed storage 201. By using separate random seeds for generating the encryption key and for generating the parameters as described above, the number of times the random seed for generating the encryption key, i.e., the algorithm for generating the encryption key, is used can be reduced as much as possible. This can provide an advantage of making it easier to ensure the confidentiality of the process for generating the encryption key.

### Other Variations

In the above-described embodiment, by obtaining a random seed generated by management server 100 from management server 100, connected device 200 stores the random seed. However, the present disclosure is not limited to this. For example, by obtaining a random seed from an external storage medium such as a Universal Serial Bus (USB) or a device different from management server 100, connected device 200 may store the random seed. Alternatively, connected device 200 may store a random seed as a result of the random seed being written to connected device 200 when connected device 200 is manufactured at a factory, for example.

Furthermore, in the above-described embodiment, a process to be performed by a specific processing unit may be performed by another processing unit. Furthermore, the order of a plurality of processes may be changed, or a plurality of processes may be executed in parallel.

Furthermore, each of the elements in the above-described embodiment may be realized by executing a software program suitable for the element. Each of the elements may be realized by means of a program executing unit, such as a Central Processing Unit (CPU) or a processor, reading and executing the software program recorded on a recording medium such as a hard disk or a semiconductor memory.

Furthermore, each of the elements may be configured in the form of a hardware product. For example, each of the elements may be a circuit (or an integrated circuit). These circuits may constitute a single circuit as a whole or may be separate circuits. These circuits may each be a general-purpose circuit or a dedicated circuit.

These general or specific aspects of the present disclosure may be implemented using a device, a method, an integrated circuit, a computer program, or a computer-readable recording medium such as a CD-ROM. Furthermore, these general or specific aspects of the present disclosure may be implemented using any combination of devices, methods, integrated circuits, computer programs, and recording media.

For example, the present disclosure may be implemented as the encrypted communication method to be executed by a computer, or a program for causing a computer to execute the encrypted communication method. The present disclosure may be implemented as a non-transitory computer-readable recording medium having recorded thereon such a program.

Forms obtained by making various modifications to each of the embodiments that can be conceived by those skilled in the art, or forms obtained by combining structural components and functions in different embodiments, without materially departing from the spirit of the present disclosure, may be included in the scope of the present disclosure.

### INDUSTRIAL APPLICABILITY

The present disclosure is useful when encrypted communication is performed between a plurality of connected devices.

1. An encrypted communication method comprising:
generating a first encryption key using a random seed stored in advance when a cryptographic scheme is updated; and
obtaining a random number to be shared with a connected device to be communicated with, by performing encrypted communication with the connected device using a cryptographic scheme that is usable by using the first encryption key generated,
wherein the random number obtained is used as a second encryption key to perform encrypted communication with the connected device.

2. The encrypted communication method according to claim 1,
wherein when a plurality of cryptographic schemes that are usable are present, a cryptographic scheme that is usable with the connected device is selected from among the plurality of cryptographic schemes, and the encrypted communication is performed using the cryptographic scheme selected.

3. The encrypted communication method according to claim 1,
wherein the cryptographic scheme is a post-quantum cryptographic scheme.

4. The encrypted communication method according to claim 1,
wherein when cryptographic scheme information indicating that the cryptographic scheme that is usable has been updated is obtained from a management server that manages the cryptographic scheme that is usable, the cryptographic scheme that is usable is updated based on the cryptographic scheme information obtained.

5. The encrypted communication method according to claim 4,
wherein the cryptographic scheme that is usable that has been updated is transmitted to an other connected device.

6. The encrypted communication method according to claim 1,
wherein a parameter of the cryptographic scheme that is usable is generated using an other random seed that is stored in advance and is different from the random seed.

7. A non-transitory computer-readable recording medium having recorded thereon a program for causing one or more processors to execute the encrypted communication method according to claim 1.

8. A connected device comprising:
an encryption key generator that generates a first encryption key using a random seed stored in advance when a cryptographic scheme is updated; and
a communicator that obtains a random number to be shared with a connected device to be communicated with, by performing encrypted communication with the connected device using a cryptographic scheme that is usable by using the first encryption key generated by the encryption key generator,
wherein the random number obtained by the communicator is used as a second encryption key to perform encrypted communication with the connected device.
